(19) United States
(12) Patent Application Publication
(10) Pub. No.: US 2015/0221048 A1
(43) Pub. Date: Aug. 6, 2015

(54) Method and system for matching a gear and travel storage for processing a transaction in an on-demand service system

(71) Applicants: Frederic Zenhausern, Fountain Hills, AZ (US); Ryan Stephen Zenhausern, Fountain Hills, AZ (US); Alissia Marguerite Zenhausern, Fountain Hills, AZ (US); Nicole Michele Zenhausern, Fountain Hills, AZ (US)

(72) Inventors: Frederic Zenhausern, Fountain Hills, AZ (US); Ryan Stephen Zenhausern, Fountain Hills, AZ (US); Alissia Marguerite Zenhausern, Fountain Hills, AZ (US); Nicole Michele Zenhausern, Fountain Hills, AZ (US)

(21) Appl. No.: 14/174,018

(22) Filed: Feb. 6, 2014

(51) Int. Cl. G06Q 50/14; G06Q 50/30; G06Q 30/06

(52) U.S. Cl. CPC G06Q 50/14; G06Q 30/0621; G06Q 50/30

(57) ABSTRACT

A matching of a traveler's gear and vehicle when engaging into an electronic transaction of on demand services, preferably for transportation. In a preferred embodiment, the present method and apparatus is suitable for assessing remotely from a digital image, the physical properties of a travel gear, for example its shape, size and weight dimensions or texture, in order to match the geometric parameters of the container storage of a vehicle, for example the trunk of an automobile, listed in a database of an electronic transportation service, in order to optimize the conditions of transportation, such as cost reduction and energy fuel efficiency, for improving the quality of the traveler's experience.

### FIELD OF THE INVENTION

The invention relates generally to methods and systems for assisting a user designing, planning, performing, engaging into or attending an event (e.g. online check-in flight reservation) that can require some activities from the user, often in companionship with the use of a personal accessory, mostly comprising processing a transaction using an algorithm system (e.g. travel reservation software application) in combination with an electronic means (e.g. communication device or mobile phone, computer, tablet PC appliance or the like), a digital network system, a repository of data (e.g. database) generating information between specific components profiling the user, integrating information features and managing the transaction resulting in optimizing the parameters of the user's participation into the event, for example validating a check-in transportation procedure or booking of a vehicle transportation (e.g. taxi, airplane seat).

### BACKGROUND

Latest advances in digital and social network products involve some transaction between a user or consumer and a supplier for which some information is exchanged through digital means. Although the prior art reports automated system for processing commercial transactions (e.g. automated teller machine, web-based travel reservation), there are no such system for linking an individual profile including physical description of some belongings (e.g. dimensions or other physical attributes of a piece of luggage) for its identification, a digital transaction, a characterization of a personal object, for example a luggage, a vehicle type and specifications, for example the dimensions of a car trunk or an airplane with specified dimensions of overhead bin storage and/or under seat space, an algorithm for pattern recognition, a measurement tool and some database(s) of information that include for example financial, schedule, itinerary or other personal features suitable for a digital transaction related to a mobile application, such as in the case of travel, that can enable benefits to a consumer, while improving efficiency of the processes related to the functional outcome such as luggage weight distribution and spatial location in an airplane that may provide further benefits in the forms of optimization of energy such as the fuel consumption of a transportation vessel, but also, for example in improving an airplane cabin boarding procedure and comfort and security of passengers, financial benefits (e.g. cost reduction) among other benefits that can be derived from the implementation of the proposed invention.

For example, most current vehicles, such as automobiles, commercial vessel including transportation freight container or the like, but in particular airplanes, are equipped with a multitude of article holders for storing and/or positioning a multitude of portable or personal articles and/or their ancillaries, such as luggage, electronic appliances (e.g. computer, mobile communication devices such as cell phones, electronic tablets, digital media players (e.g. MP3 device, video player, videogame console, or the like), personal bags, any other portable device and/or article readily available under current commercial standards that is typically accompanying an individual engaged or to be engaged in at least one activity such as travel, transportation, trafficking or the like. Most of these travel articles may be affixed to or stored in their surrounding environment, for example the overhead bin compartment of a train, maritime or air vessel, i.e. an airplane, or in a constrained space, for example, under a passenger seat in an airplane or a trunk or a seat of a car, or through readily available adaptation fixtures (i.e. independent or isolated holding means) that can connect and secure the articles to their surrounds, in particular to defined location to prevent motion while preferably allowing functional, and within specifications, operation (e.g. access of a content of a bag).

There are many consumer products in the category of travel gear ranging from suitcase, bag, box, container and so on that comprise articles packaged into these gears, for example a clothing article, documents (e.g. book, binder), electronic appliances, consumer products such as cosmetics, business or personal article(s) or any physical content to be accompanying an individual or a person who may be planning a trip or be engaged in a moving action, for example when undergoing transportation or driving a vehicle. A working point for the sake of clarification is now established by referencing article meaning an item to be related or carried out by a person as a luggage or freight to be linked with a information processing a transaction in a reservation management system, preferably through a digital, network or internet based system, preferably compatible with interfacing social network and communication systems.

It is within the scope of the present invention to provide a suitable electronic user interface means, such as an algorithm for determining some physical parameters, for example dimensions of a luggage including length, height, width, weight, geographical location or other appearance that may be extracted and analyzed from an image of said luggage for selecting an option of its handling matching of a storage means available within the specifications of a transportation vehicle, depending on the configuration and nature of the luggage, for example a travel bag, container or box, can be provided as a content information for processing a request of on-demand services using some computing systems, such as pertaining generally to system for enabling said services employed for taxi, limousine fleets or other service types with specific options that satisfy a user's request and that arrange services between said user and a service provider, preferably from the group of services related to transport, delivery, personal assistance and other service application for exchanging information, for example in real-time, and preferably specific to the user profile, selection, user location. It is also within the scope of the present invention to provide digital services components from the family of general description of on demand service application, geographical and/or navigational maps, information databases for accessing and/or downloading content information related to the user's profile, user's request, user's personal gear or luggage and a location determination. Although the present invention pertains to those skilled in the art of known prior art, the following description will be directed towards some preferred embodiments related to the combination of engaging of a user with a request for services available from an on-demand service system. In particular, attention is now directed to the description of an embodiment comprising selecting an application manager for providing services using communication exchange that can include a digital network, such as a wireless network, or other resources for processing the user's input comprising physical information related to its companion's belonging(s), user's location and user specified service request to be processed by computing and/or communication devices for translating said request into completed services that can result in delivering transportation by a vehicle.

Improved capacity in matching both a traveling object (e.g. luggage) belonging to a user engaged in on-demand transportation services with physical properties of a featured mean, for example a container of a service vehicle (e.g. trunk) that can't easily fit their sizes and shapes to provide appropriate holding can be achieved with the present invention. Examples can include the secure and precise disposition of a carton packaging box in a car trunk, onto a car seat, or any surrounds of the interior of a vehicle, for example a car, airplane, train, bicycle, motorcycle, vessel, spacecraft or any vehicle that can accommodate an individual involved in a motion or transport.

The prior art of automatic identification of features from an object to be extracted from an image for estimating some physical properties is traditionally described in pattern analysis and machine intelligence techniques [M. Kumar et al, “Image processing technique to estimate geometric parameters and volume of selected dry beans”, Food Measure, (2013), 7:81-89]. The present invention improves on optimizing the segmentation, identification and classification approaches, in particular when a travel gear is placed in a mobile surrounding environment, in particular under travel circumstances or transportation, preferably when the travel gear physical assessment is performed remotely in view of fitting a defined spatial, geometric container environment in a vehicle, for example an automobile listed in an on demand service system. None of the above inventions, publications or patents taken either singly or in combination, is seen to describe the novelty of the present invention as claimed. None of the above prior art reports adapting the most commercially readily available travel gear products, i.e. “luggage”, to common storage means of most standard vehicles. Note the present invention is also considering a diversity of product gear and vehicle types, content, texture, structure or any other parameter of a consumer product an individual may carry during a transportation using an online reservation system.

### SUMMARY

Accordingly, the embodiments presented herein can provide methods and systems for user interface comprising certain classification of on demand services relevant to the integration of user options for assessing physical properties of a gear to further identify accuracy in matching contextual information about the component of the on demand service application. The methods and systems comprise selecting, imaging, processing and identifying a personal gear for assessing its physical properties in order to determine its shape, appearance, geometric dimensions, weight, visual characteristics or other features that would possibly match the physical boundaries of a remote container, for example the trunk of an automobile, so as to enable a user selecting on demand services types, for example transportation, and infrastructure, for example a vehicle, most suited for locating, picking up, transporting and delivering said gear to a geographic region, for example a travel destination.

In one approach, the embodiments can include a method and system for integrating 3D image reconstruction, and preferably automated image processing of the gear into a set of data that can be computed by an algorithm for estimating geometric or other physical constraints and context information to optimize its integration into a type of vehicle from an on demand service system.

In one approach, the step of imaging the gear from a user using a digital camera from a personal electronic appliance, or other device the user could enable for imaging said gear, and using an image processing algorithm can include the steps of mining databases for comparative gear patterns, shape or other intrinsic features that could be used to facilitate identification accuracy; and comparing the pattern of the user gear with a comparative pattern feature of a reference gear from the database.

In one embodiment, the gear comprises a luggage linked to a traveler seeking hiring some transport service through a remote online network system, said luggage that can be imaged by a camera of the traveler's smart phone to generate an image input for a piece of computing software algorithm, preferably in the configuration of a digital application that can be downloaded from a network (e.g. iTunes™ digital store), for example from an on-demand service network, said image being processed by an identification system for estimating some physical characteristic of the gear (e.g. weight, shape) to more precisely match the specific physical parameters of a vehicle (e.g. volume of the trunk of a car) to be provided to the traveler through the on demand service provider for activating effective transportation (i.e. improved energy efficiency by reducing fuel consumption by optimizing selection of vehicle and volume of gear to be transported) of both the traveler and its gear between locations.

Other features will become more apparent to persons having ordinary skill in the art to which the method and system pertain and from the following description and claims.

### BRIEF DESCRIPTION OF THE DRAWINGS

The above and other aspects, features and advantages of the present embodiments will be more apparent from the following more particular description thereof, presented in conjunction with the following figures, wherein:

FIG. 1 is a schematic overview of the present invention illustrating an individual preparing for engaging in an activity such as traveling that will require transportation. The embodiment of FIG. 1 highlights some of the components of the infrastructure involved in providing and processing information for generating some transaction and transportation event.

FIG. 2 illustrate a system and its workflow process for an individual engaging in activities through the use of various means including preferably an on demand service system, some personal object(s), for example a traveling gear, personal electronic appliances and software application for processing images to estimate some of the specific characters and/or features of said object in order to input some qualitative and quantitative information into the service application interface for optimizing the selection of service components and content for efficient execution of the services requested by the individual, preferably through remote digital communication.

FIG. 3 is a preferred embodiment illustrating the implementation of the method of the present invention in the event of an individual requesting an on demand transportation service, for example a limousine service, for pick-up at a first location and drop-off at a second location in accordance with the method for optimizing the selection of the vehicle with the characteristics of the traveling gears in view of preferably ensuring adequate handling of the gears for possibly reducing associated operating cost and improving comfort level of the individual and/or other ancillary benefit(s) that could be derived from the transaction between the individual user and the on demand service system and/or provider.

Corresponding reference characters indicate corresponding components throughout the several views of the drawings.

### DETAILED DESCRIPTION

The following description is not to be taken in a limiting sense, but is made merely for the purpose of describing the general principles of exemplary embodiments. The scope of the invention should be determined with reference to the claims.

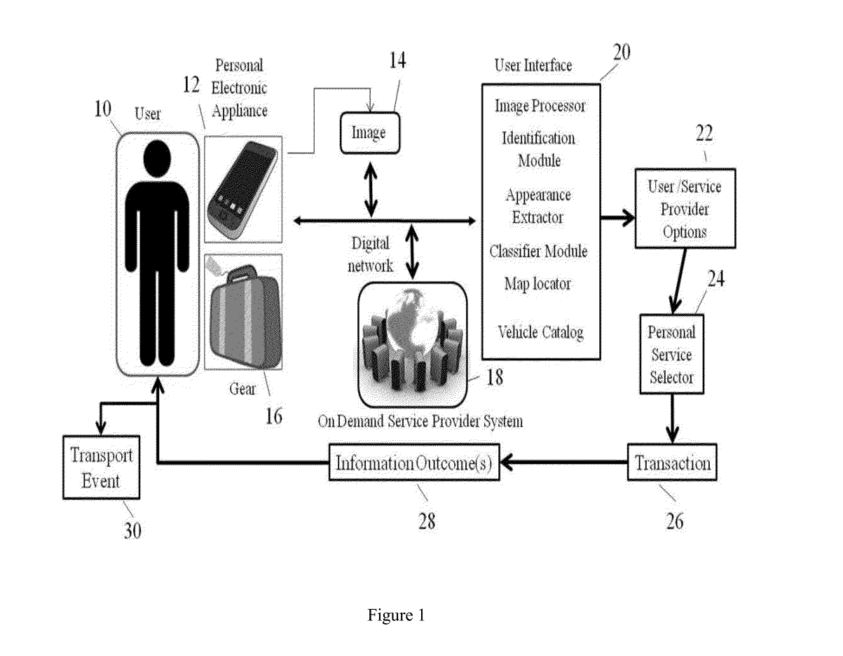

In the embodiment of FIG. 1, a user -10- using a personal electronic appliance -12-, for example from the family of electronic devices such as a smart phone, a computing tablet or laptop device, or other appliance which can also acquire and transmit a digital picture -14-, for example obtaining a digital image of said gear -16-, said appliance commonly available for communicating, computing and connecting to a network system -18-, cloud server and the like or other infrastructure required for performing an electronic transaction, preferably with a system from an on demand service provider, can interact with the service provider through a user interface -20- comprised of a series of components or modules, for example from the categories of hardware and/or software, electronic applications or other necessary component for processing said image of the gear and interrogating remotely some service options -22- accessible to the user and/or from the provider for guiding a selection of personalized service options -24- whose selected features and components, including comparing some physical properties extracted from the image of the gear and the specifications of a transportation means listed from the service provider, will assist in generating and/or managing a transaction -26-, preferably using an electronic commerce action for producing some information outcome(s) -28- of relevance to the user in order to plan, implement and execute a transport event in relation with the service provider, and preferably by optimizing some matching features between said gear and transportation means with the objective of providing the most suitable conditions for the transport event, whose conditions may include comfort, energy efficiency, cost reduction, time and distance optimization or other condition for improving the user's experience, for example when hiring a limousine service, booking a flight transport or other transportation, preferably using on demand services.

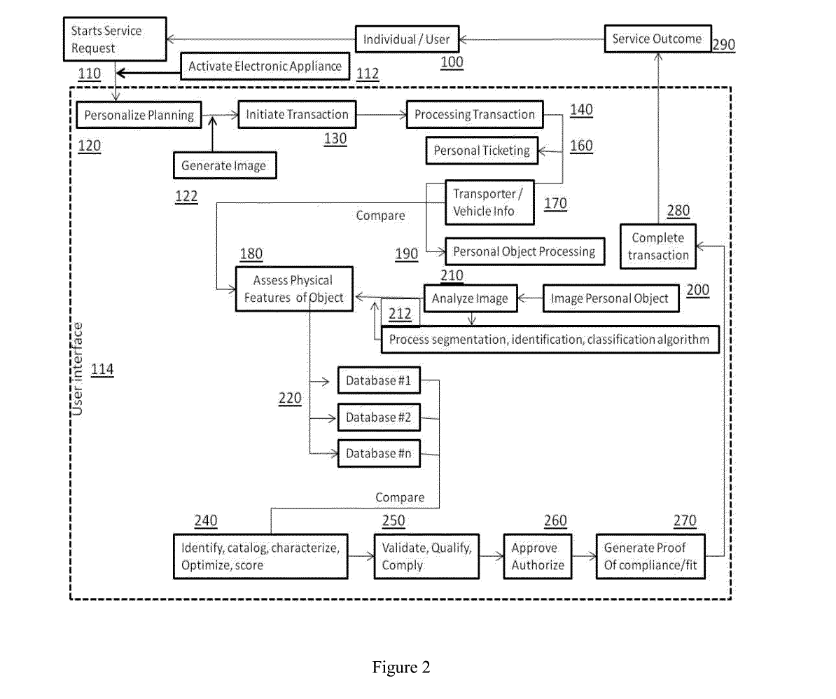

FIG. 2 illustrates the workflow processing of the present invention in a preferred embodiment wherein an individual—or user -100- can start a request for service -110- by activating an electronic appliance -112- through a user interface -114- that comprises series of components, preferably algorithm(s) or piece(s) of software allowing processing, analysis and communication of information. By using the user interface, the user can personalize planning of service activity -120-, for example by customizing some travel schedule, itinerary or financial and other administrative specifications as well as adding some information from an image generator -122- of relevance to initiating a transaction -130- that can include some characteristics enabling some personal preferences or specifications in order to optimize the transaction and the user's experience engaging services. For example, a family of features involved in the process can comprise collecting and recording data identifying or emphasizing some characteristics of a personal object or travel gear associated with the user to be carried out that may describe physical properties, for example, the appearance of a gear such as color, size, texture, and weight or so on. The processing transaction -140- can generate outcomes enabling information content specific for a personal ticketing -160- in an airplane reservation system and/or input information to a transporter vehicle information system -170- whose output information will be used in a personal object processing -190- or that can be compared to a reference module for assessing the physical features of the object -180- by interrogating some databases of information -220-. For example, a first database #1 may provide information related to a type of transport vehicle (e.g. airplane, automobile) and/or a list of specifications of a storage container that may be the recipient of said object or gear (e.g. catalog of geometric shape and dimensions of the trunk of a car, or overhead bins in an airplane). A database #2 may contain information related to manufacturer specification of travel gears (e.g. including brand name, model and dimensions), or other database #n that may be required to gather application specific information for optimizing personalization of said transaction for maximizing the qualitative and quantitative components of the transaction of a user requesting on demand services, for example a limousine service. The personal object processing will also have some functionality for acquiring/or accessing a digital image of the personal object -200- that could then be analyzed by an image processing algorithm -210-, whose analysis results can be used through a processor -212- with functionalities for segmenting, identifying and classifying of an object when differentially compared to generate an output information -240- that can identify, catalog, characterize, optimize and qualitatively or quantitatively score the object into descriptors that can be processed through a module -250- for validating, qualifying or complying the information to enable an approval or validation process for approving or authorizing -260- and generating a proof of compliance or matching score -270- for completing the transaction -280- that can result in a service outcome -290- to be accessible for personalized selection and execution by the individual user.

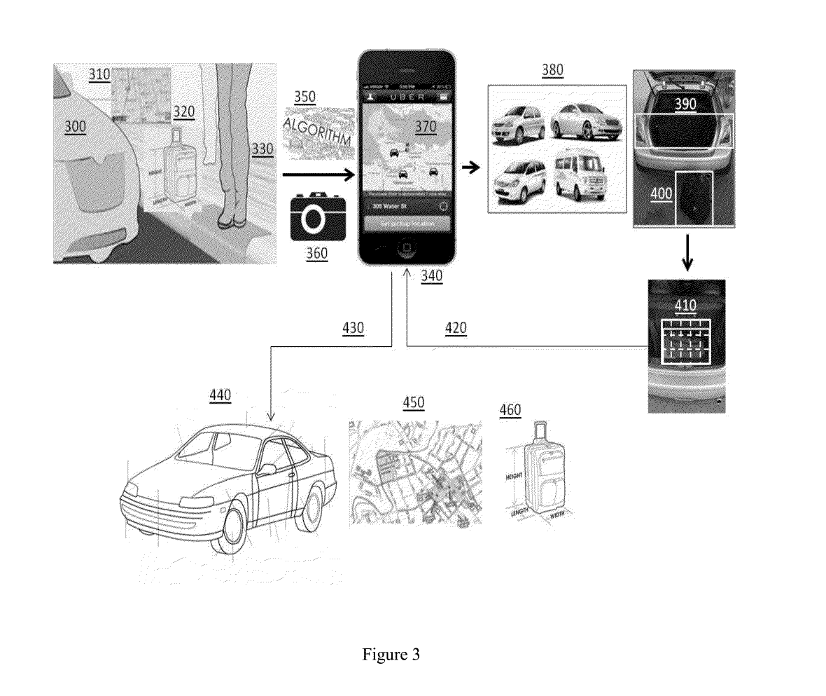

Another preferred embodiment for on demand transportation service is displayed in FIG. 3. The components comprise a vehicle -300-, a location -310- that can be mapped for its geographic location, preferably by using a GPS system, a travel gear or a piece of luggage -320- and an individual -330- planning using some transportation services. By using a personal electronic appliance -340- (e.g. smart phone), a software algorithm system -350- and an imaging processing device -360-, in combination with on demand service application -370- that can be accessed remotely for interrogating a vehicle inventory from the service provider -380- and specific information related to the physical properties of a part of a selected vehicle available from the service provider, such as the dimensions of a trunk -390- to fit the dimensions of a gear -400- to be associated with the user, images information content can be extracted -410- for assessing other physical properties of said gear (e.g. color, weight and size or shape) and vehicle carrying capacity (e.g. volume of trunk), whose information can provide additional customized information -420- about the gear for improving the likelihood of appropriate matching between the vehicle, the gear and the nature of the request from the user for optimizing the user's experience and complete the on demand service transaction -430- yielding to the vehicle pickup of the user at a first location -440- and its drop off at a second location or destination -450- with his/her personal gear -460-.

While the figures and descriptions herein have been described in conjunction with specific embodiments, many alternatives, modifications, and variations will be apparent to those skilled in the art in light of the foregoing description. Changes in form, as well as substitution of equivalents, are contemplated as circumstances may suggest or render expedient.

What is claimed is:

1. A method for performing a service transaction between at least two constituents comprising an electronic system for processing of information related to an event present or future, that involves the request for on demand carrying services by the first constituent engaging in a mobile activity, said first constituent associated with at least a gear registered at a specific location, whose appearance can be estimated for supplying some characteristic information, accordingly to requesting carrying services selections, said activity planned to move first constituent to a second location using the services of the second constituent, and said characteristic information enabling content information for processing accurately multiple options for the electronic on demand service system processing the first constituent's selections and for determining optimized conditions of the service transaction and required activity event, the method comprising:
1) Initiating a request for carrying services from a first constituent associated with a specific gear and an itinerary;
2) assessing the appearance of the gear by estimating some of its physical parameters, preferably by remote imaging processing for extracting qualitative and quantitative features information pertinent to supplying a carrying service system;
3) Computing specified information into outcome content for determining likely component of said carrying service would have sufficient and efficient resources to function, perform and deliver the actions necessary to complete the user-service.
4) Activating at least an electronic transaction between the constituents using the outcome content, and preferably related to electronic communication and/or commerce, for personalizing said services;
And
5) Completing the services by delivering the adequate component(s) for responding to the user's request that can result in performing effectively said mobile activity, preferably based on transportation.

2. A method and system using an electronic appliance, and at least an algorithm, for
remotely determining the matching appearances between a gear, an individual and a
vehicle for enabling a quality related to electronic transport services.

3. A method according to claim 2, wherein the electronic appliance is preferably from the category of computing devices, for example a smart phone, a computing tablet, a laptop computer or a communication device.

4. The method of claim 2, wherein the algorithm is from the category of image processing techniques, and preferably providing location, identification, classification for assessing at least some qualitative and/or quantitative feature(s) of said appearances.

5. The method of claim 4, whose features can comprise color, shape, texture, weight and geometric dimensions.

6. The method according to claim 2, wherein the vehicle can comprise an automobile, an airplane, a train, a bicycle, a motorcycle, a spacecraft or a boat.

7. The method of claim 2, wherein the electronic transport service is preferably an on demand transportation service such as a limousine service for pick-up and drop-off of said individual and gear between locations.

8. The method of claim 1, wherein the optimized conditions can relate to cost reduction, energy efficiency and for example fuel efficiency but also improved comfort of said user or other intangible benefit that may result from the service(s).

9. The method according to claim 1 wherein image processing can comprise several components such as image segmentation, feature extraction, classification and refinement method(s).

10. The method according to claim 1 wherein the constituents comprises a human individual or a person, a service provider through its representatives or other digital equivalent constituent able to interact through a digital network for performing an interactive transaction, for example directed to electronic commerce or other on demand service.

11. The method according to claim 1 wherein the mobile activity is a transportation, travel or displacement.

12. The method according to claim 1 wherein initiating the service request can be performed through the internet or other digital network suitable for performing an electronic service transaction.

13. The method according to claim 1, wherein processing is performed using computing devices.

14. An apparatus for performing a service transaction, the apparatus comprising:
1) one user interface for establishing communication between a user and an on demand service provider;
2) one gear to be associated with said user and requiring moving between at least two locations;
4) one personal electronic appliance for acquiring digital images;
5) one algorithm for computing image analysis for determining appearances of said gear and for processing components of said on demand services, when related to transportation;
And
6) a means for a user to access the computed information output for determining matching accuracy of said service and user's requirements for improving at least a qualitative or quantitative component of a service transaction, preferably when traveling in a vehicle.
